(19) United States
(12) Patent Application Publication
(10) Pub. No.: US 2013/0004618 A1
(43) Pub. Date: Jan. 3, 2013

(54) Animal Feed

(76) Inventor: Stefanie Alber, Heidelberg (DE)

(21) Appl. No.: 13/425,994

(22) Filed: Mar. 21, 2012

(30) Foreign Application Priority Data
Jul. 1, 2011 (DE) 10 2011 107 854.5

(51) Int. Cl. A23K 1/00; A23K 1/18; A23K 1/175

(52) U.S. Cl. 426/72; 426/537; 426/92; 426/74

(57) ABSTRACT

An animal feed with a flavor enhancer that heightens palatability, characterized in that the flavor enhancer contains 88-99% by weight collagen hydrolysate and 1-12% by weight hydroxyproline.

### BACKGROUND OF THE INVENTION

The invention relates to an animal feed with a flavor enhancer that improves palatability.

Animal feeds are known in diverse compositions for different purposes and for a variety of animals, particularly house pets. The composition of feeds for young animals, for example, is usually different from that of feeds for fully grown individuals, the composition being adjusted, to the respective physiological needs of one phase of growth. In, addition, however, certain feed compositions are known that enhance the performance of the animals, for example horses, or which are intended to take certain food intolerances into account.

Finally, the composition of an animal feed has a major influence on the health of the animals that are given these feeds. The incorrect use of feeds, can, be harmful, to animals, whereas some feeds that are used correctly, including as dietary supplements, can on the whole advantageously improve the well-being of animals or even promote the healing of diseases.

One thing that virtually all animal feeds have in common—be they animal feeds for meat eaters or plant eaters (carnivora, herbivora), for example dogs (canidae), cats (felidae), rodents (rodentia), horses (equidae), or birds (ayes)—is that they deviate from the naturally occurring form, composition, consistency, etc. with which the animals are familiar and are therefore not readily accepted by the animals. Producers of animal feeds, for example wet and dry feeds, therefore go to great trouble and expense in order to enhance the tastiness (palatability) of the animal feed and in that way to ultimately achieve very good feed intake.

For this purpose, flavor enhancers are often used as animal feed additives. These themselves have no pronounced taste of their own, but nevertheless enhance the taste of the feed in such a way that the animal (subconsciously) perceives the feed as particularly tasty and therefore readily consumes it.

However, a disadvantage of the use of flavor enhancers is that they only contribute toward improving taste but have no (other) positive physiological significance. The use of flavor enhancers thus increases the amount of work involved in producing animal feed simply for the purpose of improving feed intake, while at the same time the intake of large amounts of flavor enhancers might possibly have detrimental effects on health.

### SUMMARY OF THE INVENTION

The task of the invention is therefore to create an animal feed with additives that makes the animal feed highly, palatable, and at the same time has a beneficial physiological effect on the health of the animal.

Surprisingly, it was observed that a compound consisting of 88-99% by weight of a collagen hydrolysate and 1-12% by weight of free hydroxyproline added in a proportion of at least 0.001% by weight to an animal feed achieved an effect comparable to that of a conventional flavor enhancer, that is, it improved feed intake. This effect could be achieved with wet feeds, dry feeds, and milk, as well as with so-called “Snack & Treat” products.

### DETAILED DESCRIPTION OF THE INVENTION

In particular, a preferred embodiment of the embodiment calls for the animal feed to be provided with a coating on the outside of the feed, for example by means of spraying, preferably with the coating completely enveloping the animal feed and containing a collagen hydrolysate as well as free hydroxyproline.

However, depending on the manufacturing process, the animal feed may also have “only” a partially enveloping flavor-enhancer coating.

In particular, the flavor enhancer, or more specifically the coating containing the flavor enhancer, is comprised 88-99% by weight of a collagen hydrolysate, the collagen hydrolysate being manufactured from collagen types I, 11, and/or III. The collagen hydrolysate in particular has a molecular weight of less than 3.1 kD and a hydroxyproline content of 11-12%.

The weight of the flavor enhancer preferably amounts to 0.001 to 5% of the total weight of the animal feed (including the flavor enhancer). It is particularly preferred that the weight of the flavor enhancer amount to 0.1 to 1% of the total weight of the animal feed (including the flavor enhancer). However, if special importance is assigned to the positive mobility effect/cartilage buildup of the flavor enhancer, a higher percentage of up to approximately 10-15% by weight is conceivable.

The coating preferably contains trace elements and/or vitamins, especially preferably zinc chelate and/or biotin.

The animal feed can classically be produced as wet or dry feed, although other types of feed are also possible, for example semi-moist feed, gel, or “Snack & Treat” products.

Depending on the type of animal feed, the flavor enhancer will be mixed into or applied to the feed by means of a suitable coating method. If there are dry feed pellets, for example, a coating can be applied by spraying the pellets with an aqueous solution containing collagen hydrolysate and free hydroxyproline.

### EXAMPLE

A meat-containing “Snack & Treat” product suitable for dogs, which is available on the market and already has high palatability, was compared with a “Snack & Treat” product in accordance with the invention. The, animal feed according to the invention contained a flavor enhancer with 88-99% by weight collagen hydrolysate (molecular weight less than 3.1 kD and a hydroxyproline content of 11-12%) and 1-12% by weight free hydroxyproline, the flavor enhancer's proportion of the total feed ranging between 0.1 and 1% by weight.

The dry feed was offered to a plurality of dogs, and their feeding behavior was logged by their owners.

A total of 66.7% of the owners said the product according to the invention tasted better to the dog. Only 23.3% percent said that no difference could be observed in feeding using the two compared feeds. Only 3.3% found there was better intake of the commercially available feed without the flavor enhancers according to the invention.

In a further experiment, the feed was offered with and without the inventive flavor enhancers simultaneously in 150 feedings. The dog therefore had a choice between the feed with the inventive flavor enhancer and the feed without the inventive flavor enhancer.

In 74.7% of these instances, the inventively produced feed was eaten first by the animal taking part in the experiment. Only 21.3% of the animals ate the feed without the inventive flavor enhancers first. In 4% of the feeding experiments, the test animals exhibited no appetiteat all.

The figures for both experiments show consistent results for dog-owners on the one hand and test animals on the other, with an obvious preference for the inventive feed.

The improved palatability owing to the composition of 88-99% by weight of collagen hydrolysate and 1-12% by weight of free hydroxyproline promotes better feed intake by the animals that are to be fed, which means not only that better acceptance of already known feeds can be achieved, but also that new feed compositions that have a beneficial effect on the animal organism (for example as a dietary supplement) and that cannot be used at all as feed without the inventive flavor enhancer, or only with great difficulty, can be offered with good acceptance.

The use of collagen hydrolysate and free hydroxyproline results not only in improvement in the palatability of the feed. The oral intake of collagen hydrolysate also promotes cartilage formation, and its use as a therapeutic measure is recommended in cases of acute musculoskeletal system disease, such as arthrosis or osteoporosis, and in general as a prophylactic measure against complaints of this type. Thus, in addition to improving feed intake, the inventive flavor enhancer also serves as a dietary supplement.

1. An animal feed with a flavor enhancer that heightens palatability, characterized in that
the flavor enhancer contains 88-99% by weight collage hydrolysate and 1-12% by weight free hydroxyproline.

2. An animal feed according to claim 1, characterized in that the flavor enhancer takes the form of a coating that at least partially envelops the animal feed.

3. An animal feed according to claim 1, characterized in that the proportion of the flavor enhancer in the feed amounts to between 0.001% by weight and 1.0% by weight

4. An animal feed according to claim 1, characterized in that the collagen hydrolysate is produced from collagen types I, II, and/or III.

5. An animal feed according to claim 1, characterized in that the collagen hydrolysate has a molecular weight that is equal to or less than 3.1 kD.

6. An animal feed according to claim 1, characterized in that the collagen hydrolysate has a hydroxyproline content of 11-12%.

7. An animal feed according to claim 2, characterized in that the coating contains trace elements and/or vitamins.

8. An animal feed according to claim 7, characterized in that the coating contains zinc chelate and/or biotin.

9. An animal feed according to claim 1, characterized in that the animal feed is a dry feed.

10. An animal feed according to claim 1, characterized in that the feed is a feed for animals selected from the group consisting of dogs (banidae), cats (felidae), rodents (rodentia), horses (equidae), and birds (ayes).
